(19) United States
(12) Patent Application Publication
(10) Pub. No.: US 2006/0274419 A1
(43) Pub. Date: Dec. 7, 2006

(54) Optical multiplexer and demultiplexer

(76) Inventors: Charles Marshall, Burbank, CA (US); John A. Trepl II, Dana Point, CA (US); Roger A. Kuntz, Laguna Niguel, CA (US); Axel M. Kuntz, Lake Forest, CA (US); Vladimir Tchoutko, Irvine, CA (US)

Correspondence Address: Charles Marshall, #A, 221 North Myers Street, Burbank, CA, 91506, US

(21) Appl. No.: 11/001,211

(22) Filed: Nov. 30, 2004

(51) Int. Cl. G02B 5/32

(52) U.S. Cl. 359/580; 385/18

(57) ABSTRACT

A new optical multiplexer and filter (demultiplexer), and use thereof for writing data to and reading data from optical media. An optical filter according to a first embodiment includes a receiving port for receiving incoming light, and a plurality of substantially transparent spacers coupled together to form an assembly, the assembly having a light input surface positioned towards the receiving port. A plurality of specular devices are coupled to the spacers, each specular device being designed to reflect a single wavelength channel in a new direction and allow light of other wavelengths to pass therethrough. The process for multiplexing functions in a similar way, but the optical signals flow in an opposite direction.

### FIELD OF THE INVENTION

The present invention relates to optical filters (demultiplexers) and multiplexers and more particularly, this invention relates to a new optical filter and multiplexer and use thereof in an optical media system.

### BACKGROUND OF THE INVENTION

Existing optical filtering systems use a collection of thin film filters to demultiplex multiple optical channels on a single fiber. In such devices, a plurality of filters are deposited individually on a single substrate with a sequence of masking and deposition operations to create each filter. Each filter is designed to pass a single wavelength channel. Those channels that are not passed through the first filter are reflected toward the next filter which is designed to pass a single channel which is different from the single channel that passes through the first filter. Those channels that are not passed through the second filter are reflected in a similar manner and either pass through or are reflected by each subsequent filter. Existing optical multiplexers work similarly, but the optical signals flow in an opposite direction. As those skilled in the art will appreciate, the execution of this process for making such devices is complicated by the fact that each filter is manufactured separately, thereby requiring precise alignment of each separate filter on the substrate during deposition in order to ensure proper operation of the device. The present specification discloses novel optical filters and multiplexers, and methods for performing optical filtering and optical multiplexing that represent simplified and more reliably, processes when compared to existing systems and methods. Also disclosed are methods of using the novel optical filters and multiplexers in optical media systems.

Optical media presently include compact discs (CDs), digital video discs (DVDs), laser discs, and specialty items. Optical media has found great success as a medium for storing music, video and data due to its durability, long life, and low cost.

One problem with optical media is that current read technology only allows reading of a single light wavelength. The result is that the data density of current optical media is limited. What is therefore needed is a way to increase the data density of optical media, and the ability to read the increased data density.

### SUMMARY OF THE INVENTION

The present invention is directed to a new optical multiplexer and filter (demultiplexer), and use thereof for writing data to and reading data from optical media. An optical filter according to a first embodiment includes a receiving port for receiving incoming light, and a plurality of substantially transparent spacers coupled together to form an assembly, the assembly having a light input surface positioned towards the receiving port. A plurality of specular devices are coupled to the spacers, each specular device being designed to reflect a single wavelength channel in a new direction and allow light of other wavelengths to pass therethrough. A plurality of sensors can be provided to detect changes in the reflected light.

The specular devices can be thin film interference mirrors, e.g., metal mirrors, dielectric mirrors, metal-dielectric mirrors, cold mirrors, or combinations thereof. As an option, the final specular device positioned farthest from the receiving port can be about 100% reflective across all wavelengths. The specular devices are preferably arranged such that each specular device reflects a longer wavelength than any preceding specular device positioned closer to the receiving port. Alternatively, the specular devices can be arranged so that each specular device reflects a shorter wavelength than any preceding specular device positioned closer to the receiving port.

The assembly of spacers is preferably coupled to a single substrate. The assembly of spacers is also preferably linear along a path of the incoming light.

In one embodiment, the light input and/or output surfaces of the spacers are coated with an antireflection coating.

An optical multiplexer has a similar structure and features, and includes an outgoing port for passing outgoing light. A plurality of spacers are coupled together to form an assembly, the assembly having a light output surface positioned towards the outgoing port. A plurality of specular devices are coupled to the spacers, each specular device being designed to reflect a single wavelength channel and allow light of other wavelengths to pass therethrough. A plurality of light sources can be provided to emit light towards the specular devices.

In other embodiments, the present invention provides a system and corresponding method for reading an optical medium by reading different wavelengths of light as it reflects off of the medium. The system includes a light source for emitting light at an optical medium having features representing data, the features on the optical medium causing variations in the way the light is reflected. An optical filter separates the light reflected from the optical medium into multiple wavelengths. One or more sensors (e.g., photo diodes) detect changes in the light in the different wavelengths, the changes representing data.

In one embodiment, the optical filter and sensor(s) are present on a single chip. The reflected light can enter the chip directly or via a medium such as a fiber optic cable.

The filter acts as a demultiplexer to separate the light into at least two different wavelengths, and can separate the light into many different wavelengths, e.g., 4, 6, 8 or more. Multiple sensors can simultaneously detect changes in the light in the different wavelengths, thereby providing at least a 2× or more improvement over standard optical media systems.

In one embodiment, the surface features on the optical medium are positioned on the same layer of material of the optical medium, the surface features having differing dimensions for reflecting the light differently for each wavelength. In another embodiment, the surface features on the optical medium are positioned on different layers of material of the optical medium, the surface features having differing dimensions for reflecting the light differently for each wavelength.

A circuit is coupled to the at least one sensor. The circuit interprets signals created by the sensor(s) for converting the signal into digital data. The circuit can also be formed on the same chip as the optical filter and sensors.

The optical medium can have physical dimensions substantially the same as a standard CD or DVD, mini-CD, etc. Preferably, the system can also read data from standard CDs and DVDs for backward compatibility.

Another embodiment is capable of reading translucent media. A system for reading a translucent optical medium includes a light source for emitting light at an optical medium having features representing data, the light passing through the optical medium, the features on the optical medium causing variations in the way the light passes through the optical medium. An optical filter separates the light passing through the optical medium into multiple wavelengths. One or more sensors detect changes in the light in the different wavelengths, the changes representing the data.

Yet other embodiments are capable of writing to an optical medium. In these embodiments, light in various wavelengths is multiplexed and directed onto an optical medium, as a single beam, or demultiplexed and directed to the medium. The light in the various wavelengths creates readable surface features on the medium.

Other aspects and advantages of the present invention will become apparent from the following detailed description, which, when taken in conjunction with the drawings, illustrate by way of example the principles of the invention.

### BRIEF DESCRIPTION OF THE DRAWINGS

For a fuller understanding of the nature and advantages of the present invention, as well as the preferred mode of use, reference should be made to the following detailed description read in conjunction with the accompanying drawings.

FIG. 1 is a system diagram of an optical filtering device.

FIG. 2 is a graphical representation correlating the system of FIG. 1 with spectra parameters.

FIG. 3 is a system diagram of an optical multiplexing device.

FIG. 4 is a partial cross sectional view, not to scale, of a CD.

FIG. 5 is a partial cross sectional view, not to scale, of a single sided, dual-layer DVD.

FIG. 6A is a simplified system view of a system for reading a reflective optical medium.

FIG. 6B is a simplified system view of a system for reading a transmissive optical medium.

FIG. 7 illustrates an optical receiver formed in an integrated package according to the present invention.

### BEST MODE FOR CARRYING OUT THE INVENTION

The following description is the best embodiment presently contemplated for carrying out the present invention. This description is made for the purpose of illustrating the general principles of the present invention and is not meant to limit the inventive concepts claimed herein.

The present invention is directed to a new optical multiplexer and filter (demultiplexer), and use thereof for writing data to and reading data from optical media.

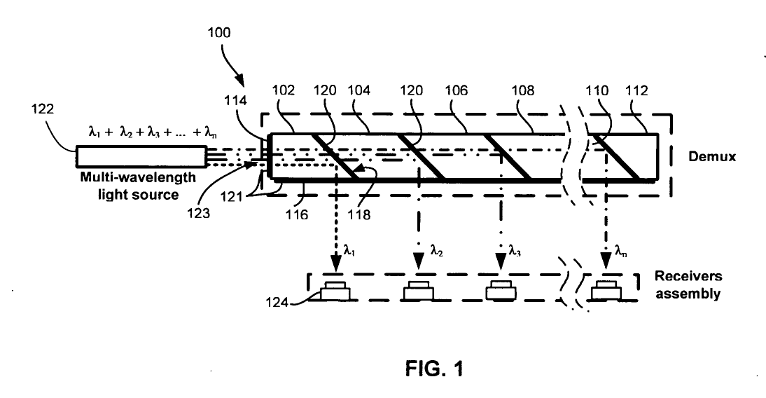

FIG. 1 illustrates an optical filter device 100 according to one embodiment. As shown, the device selects defined light wavelengths (λ₁, λ₂, . . . λₙ) and separates them into readily identifiable light streams of the defined wavelengths. As will be described in more detail below, the filter has applicability in any system in which data is transmitted in different light wavelengths. Illustrative systems include optical media (e.g., CD/DVD) reader and/or writer devices as well as more traditional systems such as fiber optic network systems, etc.

With continued reference to FIG. 1, the device 100 includes multiple spacers 102, 104, 106, 108, 110, 112 corresponding to a number of wavelengths to be separated. Each spacer includes a light input surface 114 and light output surfaces 116, 118. Output surface 116 allows output of the reflected wavelength channel and output surface 118 allows the nonreflected wavelength channels to pass therethrough. Each of these surfaces is optically polished. The spacers are made of a material transparent in the whole range of wavelengths used. A preferred material from which the spacers are constructed is polycarbonate. Polycarbonate is substantially transparent and can be easily molded to the appropriate shape in an injection molding process. Other suitable materials include glass, quartz, etc.

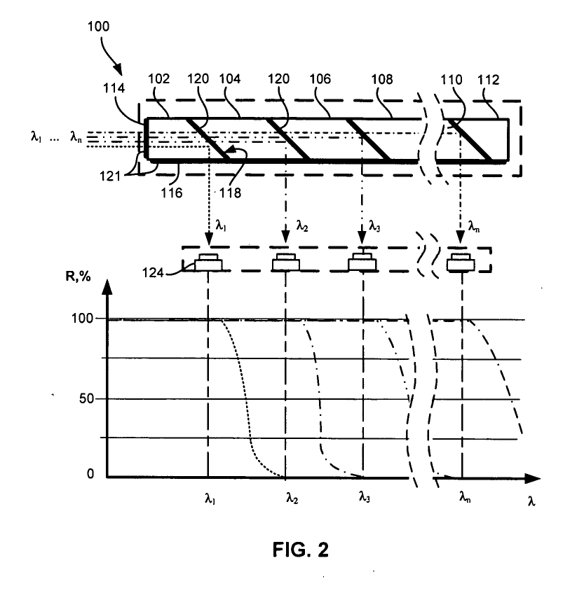

On the filtering surface of each spacer, which is preferably oriented at about a 45° angle to the incident light beam, a thin film specular device (e.g., thin film interference mirror) 120 is deposited on or laminated thereto. Each specular device 120 is spectrally selective, i.e., designed to reflect a selected wavelength channel (range) as shown in FIG. 2. Illustrative specular devices are metal mirrors, dielectric mirrors, metal-dielectric mirrors, cold mirrors, or combinations thereof The preferred mirror coatings have high reflectance at the wavelength to be reflected and high transmittance for the wavelengtho to be transmitted to the following mirrors. Suitable dielectric thin film materials are available from Zygo Corporation, Laurel Brook Road, Middlefield, Conn. 06455-0448 USA and Denton Vaccum, 1259 North Church St., Moorestown, N.J. 08057 USA. Also note that the final specular device can be about 100% reflective across all wavelengths.

In one embodiment, cold mirrors are used. A cold mirror reflects shorter wavelengths and transmits longer wavelengths. Illustrative cold mirrors can be formed of layers of SiO₂ and/or TiO₂. One illustrative cold mirror includes a coating consisting of multiple layers of SiO₂ and TiO₂ on a glass substrate.

In a variation, alternating spacers can have two filtering surfaces with mirrors, one on either end. For example, in FIG. 1, spacers 104 and 108 would have mirrors on both ends thereof, while spacers 102, 106 would not have any mirrors coupled thereto. This allows the number of spacers that need to be processed in the mirror-adding step to be cut roughly in half.

The light input and output surfaces of each spacer are preferably coated with a broadband antireflection (BBAR) coating 121 for decreasing any back reflection in a whole range of used light wavelengths. Table 2 lists several suitable BBAR coatings and their properties.

TABLE 2

| Coating Type | Properties and Applications |
|---|---|
| Single Layer MgF₂ | Applied to materials with refractive indices from |
| | 1.45 to 2.4. The most popular antireflective (AR) |
| | coating for visible spectrum. It is insensitive to |
| | change in incidence angle. |
| Multilayer | Used to provide low reflectance with in a narrow |
| | durable wavelength band for most laser applications. |
| | Minimum reflection can be less than 0.1%. |
| Broadband | Excellent performance over a broad range of |
| Multilayer | spectrum. Coating performance is sensitive to angle |
| | of incidence. |

These BBAR coatings are available for purchase from Red Optronics, P.O. Box 2032, Mountain View, Calif. 94042, USA.

One skilled in the art will appreciate that other materials, currently sold and those yet to be invented, can be used to construct the specular devices 120 and BBAR coatings 121 without straying from the spirit and scope of the invention.

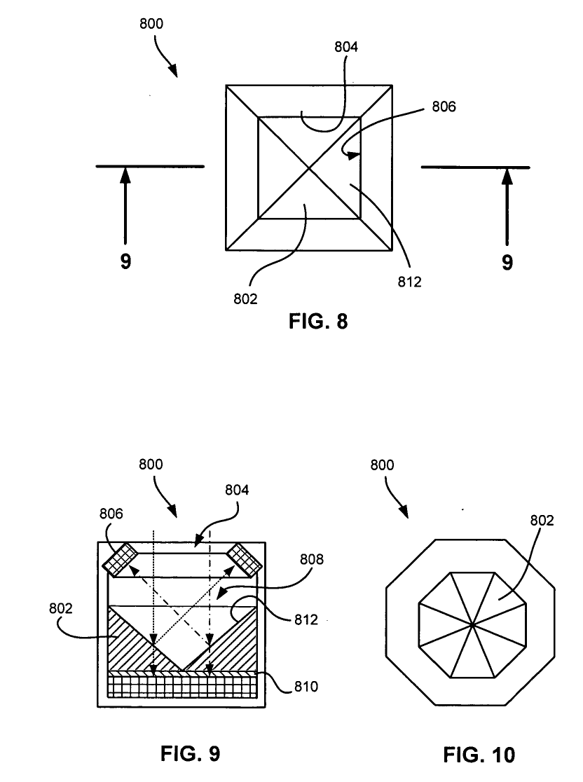

To construct the device 100, the spacers are glued together in a sequence of specular devices with design wavelength reflectivity increasing from the input to the final spacer. The assembly can be assembled on a single substrate piece by piece, or can be glued thereto as a partially or fully assembled assembly. Note FIG. 7.

The device works to demultiplex an incoming light beam as follows. The collimated light beam with wavelengths λ₁, or λ₂>λ₁, or λ₃>λ₂>λ₁, or kₙ . . . >λ₃>λ₂>λ₁ is directed from a multi-wavelength light source 122 (e.g., fiber optic cable) through a receiving port 123 into the light input surface of the device. The light having the shortest selected wavelength λ₁ is nearly completely reflected by the first specular device to the accordable receiver. Those wavelengths λ₂-λₙ that are not reflected pass through the first specular device to the next specular device which is designed to reflect a single channel λ₂ which is different from the single channel λ₁ reflected by the first specular device. The light having a wavelength λ₂ (>λ₁) is nearly completely transmitted by the first specular device and nearly completely reflected by the next specular device to the appropriate receiver. Those channels that are not reflected by the second specular device either pass through or are reflected by each subsequent specular device. Optical signals (each of which corresponds to a particular wavelength) then pass out of the device and are directed to the sensors 124 (e.g., photo diodes). Each sensor 124 converts one of the optical signals output from the filter into a corresponding electrical signal. As an option, lenses (not shown) may be placed between the sensors 124 and device to improve device performance.

The specular devices are preferably arranged such that each specular device reflects a longer wavelength than any preceding specular device positioned closer to the receiving port. Alternatively, the specular devices can be arranged so that each specular device reflects a shorter wavelength than any preceding specular device positioned closer to the receiving port.

The range of readable wavelengths can be as broad or narrow as desired, and can include visible as well as UV and IR light.

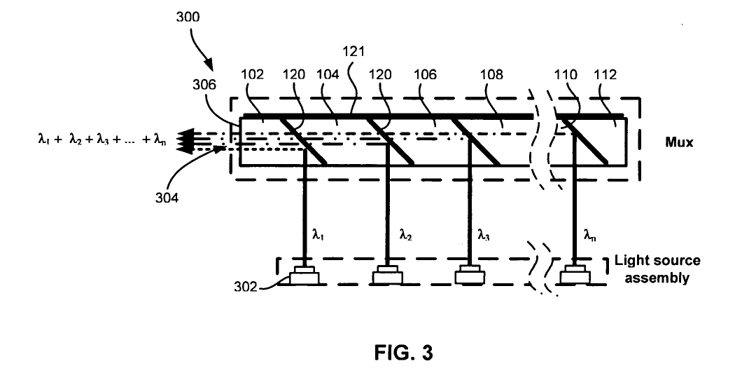

The process for multiplexing functions in a similar way, but the optical signals flow in an opposite direction. As shown in FIG. 3, instead of sensors, light sources 302 (e.g., light emitting diodes and filters if required) are added to the system 300. Each light source emits flashes of light towards the associated specular device 120. Note that the light beam emitted by each light source can be in a similar or same wavelength spectrum. Each specular device reflects only the desired wavelength channel and allows the rest of the light to pass therethrough, where it is absorbed by the BBAR coating 121. The receiving port then becomes an outgoing port 304 which passes light from the output surface 306 of the spacer/specular device assembly. And assuming that the specular device selected is bireflectional, i.e., each side reflects the selected wavelength channel, then the specular devices positioned towards the outgoing port would deflect any light in the selected wavelength coming from specular devices positioned farther from the outgoing port. The same effect could also be achieved by adding duplicate specular devices facing opposite directions.

As mentioned above, the device is suitable for use in a reader and/or writer for optical media. Optical media presently include compact discs (CDs), digital video discs (DVDs), laser discs, and specialty items. Optical media has found great success as a medium for storing music, video and data due to its durability, long life, and low cost.

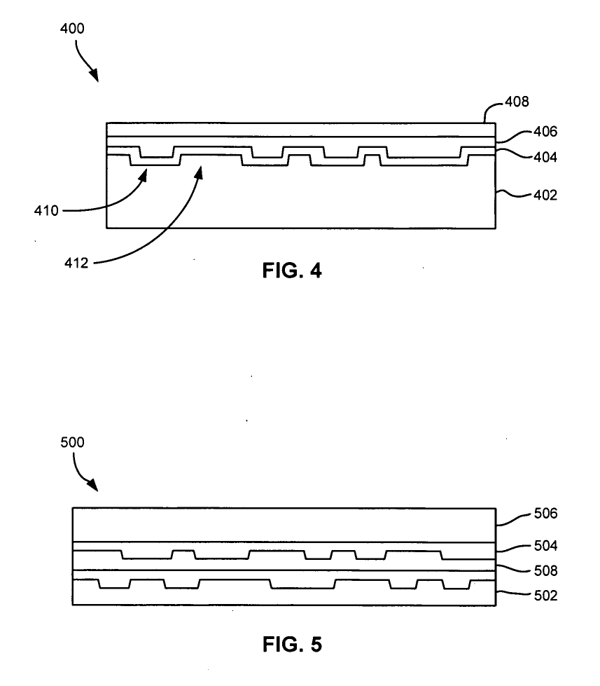

A CD typically comprises an underlayer of clear polycarbonate plastic. During manufacturing, the polycarbonate is injection molded against a master having protrusions (or pits) in a defined pattern that creates an impression of microscopic bumps arranged as a single, continuous, spiral track of data on the polycarbonate. Then, a thin, reflective aluminum layer is sputtered onto the disc, covering the bumps. Next a thin acrylic layer is sprayed over the aluminum to protect it. A label is then printed onto the acrylic. FIG. 4 illustrates a cross section of a typical data or audio CD 400, particularly depicting the polycarbonate layer 402, aluminum layer 404, acrylic layer 406, label 408, and pits 410 and lands 412 that represent the data stored on the CD 400. Note that the “pits” 410 are as viewed from the aluminum side, but on the side the laser reads from, they are bumps. The elongated bumps that make up the data track are each 0.5 microns wide, a minimum of 0.84 microns long and 125 nanometers high. The dimensions of a standard CD is about 1.2 millimeters thick and about 4.5 inches in diameter. A CD can hold about 740 MB of data.

During playback, the reader's laser beam passes through the polycarbonate layer, reflects off the aluminum layer and hits an opto-electronic device that detects changes in light. The bumps reflect light differently than the lands, and an opto-electronic sensor detects that change in reflectivity. The electronics in the reader interpret the changes in reflectivity in order to read the bits that make up the data.

The data stored on the CD is retrieved by a CD player that focuses a laser on the track of bumps. The laser beam passes through the polycarbonate layer, reflects off the aluminum layer and hits an opto-electronic device that detects changes in light. The bumps reflect light differently than the lands, and the opto-electronic sensor detects that change in reflectivity. The electronics in the drive interpret the changes in reflectivity in order to read the bits that make up the bytes.

A DVD is very similar to a CD, and is created and read in generally the same way (save for multilayer DVDs, as described below). However, a standard DVD holds about seven times more data than a CD.

Single-sided, single-layer DVDs can store about seven times more data than CDs. A large part of this increase comes from the pits and tracks being smaller on DVDs. Table 3 illustrates a comparison of CD and DVD specifications.

TABLE 3

| Specification | CD | DVD |
|---|---|---|
| Track Pitch | 1600 nanometers | 740 nanometers |
| Minimum Pit Length | 830 nanometers | 400 nanometers |
| (single-layer DVD) | | |
| Minimum Pit Length | 830 nanometers | 440 nanometers |
| (double-layer DVD) | | |

To increase the storage capacity even more, a DVD can have up to four layers, two on each side. The laser that reads the disc can actually focus on the second layer through the first layer. Table 4 lists the capacities of different forms of DVDs.

TABLE 4

| Format | Capacity | Approx. Movie Time | |
|---|---|---|---|
| Single-sided/single-layer | 4.38 GB | 2 | hours |
| Single-sided/double-layer | 7.95 GB | 4 | hours |
| Double-sided/single-layer | 8.75 GB | 4.5 | hours |
| Double-sided/double-layer | 15.9 GB | Over 8 | hours |

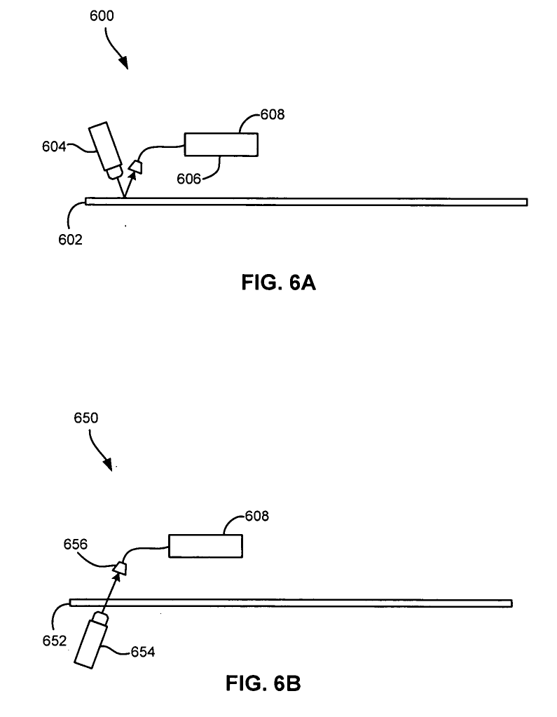

A DVD is composed of several layers of plastic, totaling about 1.2 millimeters thick. FIG. 5 depicts the cross section of a single sided/double-layer DVD 500. Each layer is created by injection molding polycarbonate plastic against a master, as described above. This process forms a disc 500 that has microscopic bumps arranged as a single, continuous and extremely long spiral track of data. Once the clear pieces of polycarbonate 502, 504 are formed, a thin reflective layer is sputtered onto the disc, covering the bumps. Aluminum 506 is used behind the inner layers, but a semi-reflective gold layer 508 is used for the outer layers, allowing the laser to focus through the outer and onto the inner layers. After all of the layers are made, each one is coated with lacquer, squeezed together and cured under infrared light. For single-sided discs, the label is silk-screened onto the nonreadable side. Double-sided discs are printed only on the nonreadable area near the hole in the middle. Cross sections of the various types of completed DVDs (not to scale) look like this

A DVD player functions similarly to the CD player described above. However, in a DVD player, the laser can focus either on the semi-transparent reflective material behind the closest layer, or, in the case of a double-layer disc, through this layer and onto the reflective material behind the inner layer. The laser beam passes through the polycarbonate layer, bounces off the reflective layer behind it and hits an opto-electronic device, which detects changes in light.

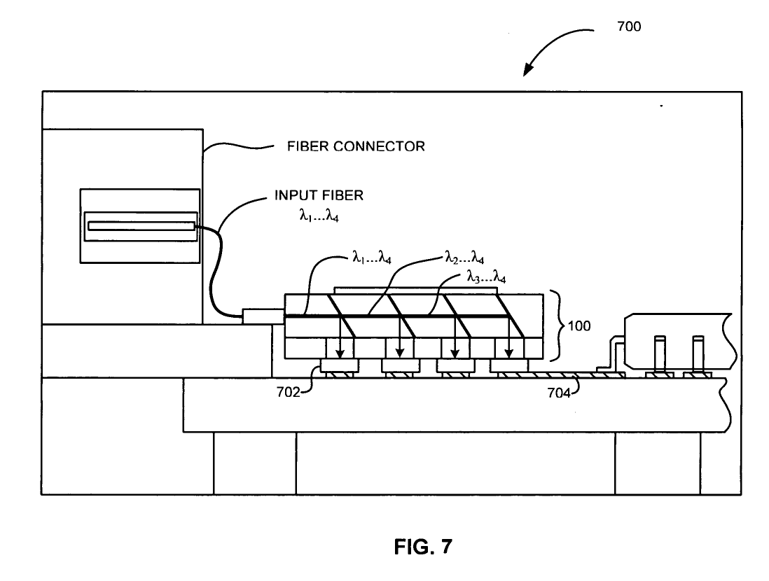

FIG. 6 illustrates a system 600 for reading an optical medium 602 by reading different wavelengths of light as it reflects off of the medium. The system 600 includes a light source 604 for emitting light at a rotating optical medium 602 having features representing data, the features on the optical medium causing variations in the way the light is reflected. The light source can be a tunable laser capable of emitting light in various wavelengths. The system is also UV capable.

An optical filter such as the one described above separates the light reflected from the optical medium into multiple wavelengths. One or more sensors (e.g., photo diodes, not shown) detect changes in the light in the different wavelengths, and output signals representing data based on the changes. During playback, the system 600 functions in generally the same way as a standard CD or DVD reader, moving the light source 604, filter and sensors along the medium to follow the data track(s) thereon.

In a preferred embodiment, the optical filter and sensor(s) are present on a single chip 606. The reflected light can enter the filter directly or via a medium such as a fiber optic cable.

The filter acts as a demultiplexer to separate the light into at least two different wavelengths, and can separate the light into many different wavelengths, e.g., 2, 3, 4, 5, 6, 7, 8 or more. Multiple sensors can simultaneously detect changes in the light in the different wavelengths, thereby providing at least a 2× or more improvement over standard optical media systems.

A circuit 608 is coupled to the at least one sensor. The circuit interprets signals created by the sensor(s) for converting the signal into digital data, much in the same way as a standard DVD player interprets data signals during playback. The circuit can also be formed on the same chip as the optical filter and sensors.

The optical medium itself is much like the CDs and DVDs described above. However, the surface features on the optical medium have differing dimensions and/or properties for reflecting the light differently for each wavelength. For example, one set of features can be set with dimensions for a first wavelength and another set of features can be set with dimensions for a second wavelength. The characteristics of the reflected light will vary based on these features, the variations being readable by detecting changes at particular wavelengths in the reflected light. When reading the features set to the first wavelength, the system will recognize a coherent data stream coming from the sensor for that wavelength, and variations in the other wavelengths at that particular sensor will either be blocked by optical filtration, or will be recognized and filtered out by the system as junk. The other sensors will likewise provide a stream of data for the other wavelengths.

The surface features can be positioned on the same layer of material of the optical medium, and aligned in vertical layers and/or in horizontal spirals. The surface features can also be positioned on different layers of material of the optical medium but along the same data track, much in the same way multi-layer DVDs are created. Note FIG. 4 and related discussion.

The optical medium can have physical dimensions substantially the same as a standard CD or DVD, mini-CD, etc. Preferably, the system can also read data from standard CDs and DVDs for backward compatibility.

Another embodiment is capable of reading transmissive media. This embodiment is shown in FIG. 6B. A system 650 for reading a transmissive optical medium 652 includes a light source 654 for emitting light at an optical medium 652 having features representing data, the light passing through the optical medium 652, the features on the optical medium 652 causing variations in the way the light passes through the optical medium 652. An optical filter 656 separates the light passing through the optical medium 652 into multiple wavelengths. One or more sensors (not shown) of the optical filter 656 detect changes in the light in the different wavelengths, the changes representing the data.

Referring now to FIG. 7, there is shown a diagram illustrating an optical receiver formed in a single integrated package, according to the present invention. Optical receiver 700 includes an array of photo diodes 702 which have been surface mounted to board 704. An optical filter 100 is then affixed immediately above the photo diodes 702. The array of photo diodes 702 and optical filter 100 may be combined into a single integrated optical package, that can then be surface mounted on circuit board 704. During operation of the receiver circuit 608, an input optical fiber carries a multiplexed optical signal representing a combination of optical signals at different wavelengths. The multiplexed optical signal is provided to the transport region of filter 100, where it is sequentially applied to each of the optical structures 406. As shown in FIG. 7, each of the mirrors 120 in filter 100 is tuned to reflect a particular wavelength of light. Optical signals (each of which corresponds to a particular wavelength) then pass out of filter 100 and are provided to the photo diodes 702. Each photo diode 702 converts one of the optical signals output from filter 100 into a corresponding electrical signal. In this embodiment, lenses may be placed between photo diodes 702 and optical filter 100 to improve device performance.

Other embodiments of integrated receivers may stack and bond separate chips containing optical filters 400 and arrays of photo diodes 702. In these embodiments, multiple device units might be stacked and bonded and then diced from the resulting structure to yield individual devices. The purpose of such assemblies and techniques is to reduce size and cost, improve alignment of the separate optical structures, and improve performance of the resulting assemblies. These assemblies may then be packaged or mounted directly on an optical circuit board to function with other optical and electrical elements.

Yet other embodiments use the multiplexing embodiment 300 to write data to an optical medium. In one such embodiment, light of various selected wavelengths can be transmitted in the same beam onto the surface of the optical medium to create the aforementioned pits and lands or their equivalent. One preferred embodiment directs the multiplexed light onto a stack of layers, each layer being responsive to light in a particular wavelength. As the light travels through the layers, each wavelength channel modifies the surface of the corresponding optical medium such as by changing the color of a dye or by altering the physical or chemical structure of the particular layer in a readable way. In another embodiment, the multiplexed light is demultiplexed back into the various wavelength channels, and the various channels are emitted onto the optical medium to create the readable features.

FIG. 8 illustrates yet another embodiment of an optical filter (demultiplexer) 800. As shown, the filter 800 includes several specular devices 802 arranged in a geometric pattern around an receiving port 804. Receivers 806 are also positioned around the receiving port 804. As shown in FIG. 9, light enters the receiving port. The specular devices 802 each reflect a different wavelength channel towards an oppositely positioned receiver 806. The nonreflected light can pass through the specular devices 802 and be absorbed by a light-absorbing material 810.

The interior of the filter 800 can have an open configuration, i.e., can have a void in the central portion 808 below the receiving port 804. Alternatively, the central portion 808 can have a material therein that is transparent in the incoming wavelength range.

FIG. 10 illustrates a variation on the filter 800 of FIG. 8. Here, the filter 800 has eight specular devices 802 instead of four. One skilled in the art will understand that any number of specular devices 802 can be implemented in such a filter 800.

In the embodiments shown, the faces 812 of the specular devices 802 face inwardly. However, one skilled in the art will understand that the faces 812 could also face outwardly, be aligned in a linear fashion, etc. so long as the receivers 806 are appropriately positioned to receive the reflected light.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

1. An optical filter, comprising:
a receiving port for receiving incoming light;
a plurality of spacers coupled together to form an assembly, the assembly having a light input surface positioned towards the receiving port; and
a plurality of specular devices coupled to the spacers, each specular device being designed to reflect a single wavelength channel in a new direction and allow light of other wavelengths to pass therethrough.

2. The filter as recited in claim 1, wherein at least some the specular devices are thin film interference mirrors.

3. The filter as recited in claim 1, wherein the specular devices are selected from a group consisting of metal mirrors, dielectric mirrors, metal-dielectric mirrors, cold mirrors, and combinations thereof.

4. The filter as recited in claim 1, wherein a final specular device positioned farthest from the receiving port is about 100% reflective across all wavelengths.

5. The filter as recited in claim 1, wherein the specular devices are arranged such that each specular device reflects a longer wavelength than any preceding specular device positioned closer to the receiving port.

6. The filter as recited in claim 1, wherein the assembly of spacers is coupled to a single substrate.

7. The filter as recited in claim 1, wherein the assembly of spacers is linear along a path of the incoming light, the specular devices being positioned between the spacers such that the spacers and specular devices form portions of a continuous structure.

8. The filter as recited in claim 1, wherein at least light input and output surfaces of the spacers are coated with an antireflection coating.

9. The filter as recited in claim 1, further comprising a plurality of sensors for detecting changes in the reflected light.

10. An optical filter, comprising:
a receiving port for receiving incoming light;
a plurality of spacers coupled together to form a linear assembly, the assembly having a light input surface positioned towards the receiving port, the assembly being coupled to a single substrate;
a plurality of specular devices positioned between the spacers, each specular device being designed to reflect a single wavelength channel in a new direction and allow light of other wavelengths to pass therethrough, wherein the specular devices are arranged such that each specular device reflects a longer wavelength than any preceding specular device positioned closer to the receiving port; and
a plurality of sensors for detecting changes in the reflected light.

11. The filter as recited in claim 10, wherein at least some the specular devices are thin film interference mirrors.

12. The filter as recited in claim 10, wherein the specular devices are selected from a group consisting of metal mirrors, dielectric mirrors, metal-dielectric mirrors, cold mirrors, and combinations thereof.

13. The filter as recited in claim 10, wherein a final specular device positioned farthest from the receiving port is about 100% reflective across all wavelengths.

14. The filter as recited in claim 10, wherein at least light input and output surfaces of the spacers are coated with an antireflection coating.

15. An optical multiplexer, comprising:
an outgoing port for passing outgoing light;
a plurality of spacers coupled together linearly to form an assembly, the assembly having a light output surface positioned towards the outgoing port; and
a plurality of specular devices coupled to the spacers, each specular device being designed to reflect a single wavelength channel towards the outgoing port and allow light of other wavelengths to pass therethrough.

16. The multiplexer as recited in claim 15, wherein at least some the specular devices are thin film interference mirrors.

17. The multiplexer as recited in claim 15, wherein the specular devices are selected from a group consisting of metal mirrors, dielectric mirrors, metal-dielectric mirrors, cold mirrors, and combinations thereof.

18. The multiplexer as recited in claim 15, wherein a final specular device positioned farthest from the outgoing port is about 100% reflective across all wavelengths.

19. The multiplexer as recited in claim 15, wherein the specular devices are arranged such that each specular device reflects a longer wavelength than any preceding specular device positioned closer to the outgoing port.

20. The multiplexer as recited in claim 15, wherein the assembly of spacers is coupled to a single substrate.

21. The multiplexer as recited in claim 15, wherein the assembly of spacers is linear along a path of the outgoing light.

22. The multiplexer as recited in claim 15, wherein at least some of the surfaces of the spacers are coated with an antireflection coating.

23. The multiplexer as recited in claim 15, further comprising a plurality of light sources for emitting light towards the specular devices, each of the specular devices reflecting light of a different wavelength.

24. An optical multiplexer, comprising:
an outgoing port for passing outgoing light,
a plurality of spacers coupled together to form a linear assembly, the assembly having a light output surface positioned towards the outgoing port, the assembly being coupled to a single substrate;
a plurality of specular devices positioned between the spacers, each specular device being designed to reflect a single wavelength channel towards the outgoing port and allow light of other wavelengths to pass therethrough, wherein the specular devices are arranged such that each specular device reflects a longer wavelength than any preceding specular device positioned closer to the outgoing port; and
a plurality of light sources for emitting light towards the specular devices, each of the specular devices reflecting light of a different wavelength.

25. A system for reading an optical medium, comprising:
a light source for emitting light at an optical medium having features representing data, the light being reflected by the optical medium, the features on the optical medium causing variations in the way the light is reflected;
an optical filter as recited in claim 1 for separating the light reflected from the optical medium into multiple wavelengths; and
at least one sensor for detecting changes in the light in the different wavelengths, the changes representing data.

26. The system as recited in claim 25, wherein the optical filter and at least one sensor are present on a single chip.

27. The system as recited in claim 26, wherein the reflected light enters the chip directly.

28. The system as recited in claim 26, wherein a fiber optic cable carries the reflected light to the chip.

29. The system as recited in claim 25, wherein the light is separated into at least two different wavelengths.

30. The system as recited in claim 25, wherein the light is separated into at least four different wavelengths.

31. The system as recited in claim 25, wherein the light is separated into at least six different wavelengths.

32. The system as recited in claim 25, wherein the light is separated into at least eight different wavelengths.

33. The system as recited in claim 25, wherein multiple sensors are present, the sensors simultaneously detecting changes in the light in the different wavelengths.

34. The system as recited in claim 25, wherein the surface features on the optical medium are positioned on the same layer of material of the optical medium, the surface features having differing dimensions for reflecting the light differently for each wavelength.

35. The system as recited in claim 25, wherein the surface features on the optical medium are positioned on different layers of material of the optical medium, the surface features having differing dimensions for reflecting the light differently for each wavelength.

36. The system as recited in claim 25, further comprising a circuit coupled to the at least one sensor, the circuit interpreting signals created by the at least one sensor for converting the signal into digital data.

37. The system as recited in claim 36, wherein the light is separated and detected on a single chip, wherein the circuit is formed on the same chip.

38. The system as recited in claim 25, wherein the optical medium has physical dimensions substantially the same as a standard compact disc (CD).

39. The system as recited in claim 25, wherein the system can also read data from a standard compact disc (CD).

40. The system as recited in claim 25, wherein the system can also read data from a standard digital video disc (DVD).

41. A system for reading an optical medium, comprising:
a light source for emitting light at an optical medium having features representing data, the light being reflected by the optical medium, the features on the optical medium causing variations in the way the light is reflected;
an optical filter as recited in claim 10 for separating the light reflected from the optical medium into multiple wavelengths; and
at least one sensor for detecting changes in the light in the different wavelengths, the changes representing data.

42. A method for reading an optical medium, comprising:
emitting light at an optical medium having features representing data, the light being reflected by the optical medium, the features on the optical medium causing variations in the way the light is reflected;
separating the light reflected from the optical medium into multiple wavelengths; and
detecting changes in the light in the different wavelengths, the changes representing the data.

43. A system for reading a translucent optical medium, comprising:
a light source for emitting light at an optical medium having features representing data, the light passing through the optical medium, the features on the optical medium causing variations in the way the light passes through the optical medium;
an optical filter as recited in claim 1 for separating the light passing through the optical medium into multiple wavelengths; and
at least one sensor for detecting changes in the light in the different wavelengths, the changes representing the data.

44. A system for writing data to an optical medium, comprising:
an optical multiplexer;
multiple light sources for emitting light at the optical multiplexer, the multiplexer multiplexing the emitted light in multiple wavelength channels;
a mechanism for directing the multiplexed light onto at least one layer of an optical medium, each wavelength channel creating features representing data on at least one of the layers.

45. The system as recited in claim 44, wherein the optical multiplexer comprises:
an outgoing port for passing outgoing light;
a plurality of spacers coupled together to form an assembly, the assembly having a light output surface positioned towards the outgoing port; and
a plurality of specular devices coupled to the spacers, each specular device being designed to reflect a single wavelength channel and allow light of other wavelengths to pass therethrough.

46. The system as recited in claim 44, wherein the light sources each emit a light beam having a similar wavelength spectrum, the multiplexer outputting a selected wavelength channel from each of the light beams from the light sources, the wavelength channels being different for each of the light beams.

47. The system as recited in claim 44, wherein the surface features on the optical medium are positioned on the same layer of material of the optical medium, the surface features having differing dimensions for reflecting the light differently for each wavelength.

48. The system as recited in claim 44, wherein the surface features on the optical medium are positioned on different layers of material of the optical medium, the surface features having differing dimensions for reflecting the light differently for each wavelength.

49. The system as recited in claim 44, wherein the optical medium has physical dimensions substantially the same as a standard compact disc (CD).

50. The system as recited in claim 44, wherein the system can also read data from a standard compact disc (CD).

51. The system as recited in claim 44, wherein the system can also read data from a standard digital video disc (DVD).

52. A method for writing data to an optical medium, comprising:
receiving light from multiple light sources;
multiplexing the emitted light in multiple wavelength channels; and
directing the multiplexed light onto at least one layer of an optical medium, each wavelength channel creating features representing data on at least one of the layers.

53. An optical filter, comprising:
a receiving port for receiving incoming light; and
a plurality of specular devices coupled to the spacers, each specular device being designed to reflect a single wavelength channel in a new direction and allow light of other wavelengths to pass therethrough;
wherein faces of the specular devices face inwardly and are arranged in a generally geometric pattern.
